(19) United States
(12) Patent Application Publication
(10) Pub. No.: US 2003/0201978 A1
(43) Pub. Date: Oct. 30, 2003

(54) Mouse capable of detecting physiological signal and environmental luminance

(75) Inventors: Chao-Fa Lee, Taipei (TW); Ya-Ting Lu, Taipei (TW); Kuo-Long Yang, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/162,667

(22) Filed: Jun. 6, 2002

(30) Foreign Application Priority Data
Apr. 26, 2002 (TW) 91108774

(51) Int. Cl. G09G 5/08

(52) U.S. Cl. 345/163

(57) ABSTRACT

A mouse capable of detecting physiological signal and detecting environmental luminance is disclosed, which has a shell and a base. A recess is defined in the shell to hold a user's finger. A photo sensor is provided between the wall of the recess and the finger for detecting the environmental photo signal that penetrates through the finger. The photo sensor sends the detected photo signal to a computer via an input/output interface, so that the computer can determine and display the user's physiological state.

### BACKGROUND OF THE INVENTION

1. Field of the Invention

The present invention relates to a mouse capable of detecting physiological signal and environmental luminance, and more particularly, to a mouse having a photo sensor for detecting environmental luminance measuring the human pulses.

2. Description of Related Art

Due to the advance of the information technology and high-technique industry, the working pressure is increased greatly, particularly to the computer workers. The computer workers always use the computers for a long time and in a high working pressure environment. They also sit in working and thus lacking exercise. Therefore, the computer workers are likely to have sickness with blood vessel, which may cause a sudden death. Therefore, it is very impotent to monitor the physiological state of the computer worker at anytime.

The mouse is a tool that computer workers use frequently for operating the computers. Furthermore, the widely used method to detect the physiological state of human beings is to measure the human pulses for getting the number of the heartbeats. Therefore, there is a desire to make the mouse capable of measuring the human physiological state, whereby the physiological state of the computer worker can be monitored at any time.

### SUMMARY OF THE INVENTION

One object of the present invention is to provide a mouse which can measure the number of heartbeats for detecting the human physiological state.

Another object of the present invention is to provide a mouse which can detect environmental luminance for reminding the user to relax their eyes.

To achieve the above objects, there is provided a mouse capable of detecting physiological signal and environmental luminance, which comprises: a housing having a base and a shell fixed on the base, the shell having plural buttons, and a recess for receiving a human finger, the recess having a first photo sensor for detecting signal emitted from a light source; and a printed circuit board for processing control signal generated by the plural buttons and receiving photo signal received by the first photo sensor, and sending the signals to a computer connected with the mouse via an input/output interface, such that the computer determines and displays human physiological state and based on the photo signals.

Other objects, advantages, and novel features of the invention will become more apparent from the following detailed description when taken in conjunction with the accompanying drawings.

### BRIEF DESCRIPTION OF THE DRAWINGS

FIG. 1 shows an exploded view of a mouse capable of detecting physiological signal and environmental luminance in accordance with the present invention.

FIG. 2 is a functional block diagram of the mouse capable of detecting physiological signal and environmental luminance in accordance with the present invention.

FIG. 3 schematically illustrates the use of the mouse capable of detecting physiological signal and environmental luminance in accordance with the present invention.

### DETAILED DESCRIPTION OF THE PREFERRED EMBODIMENT

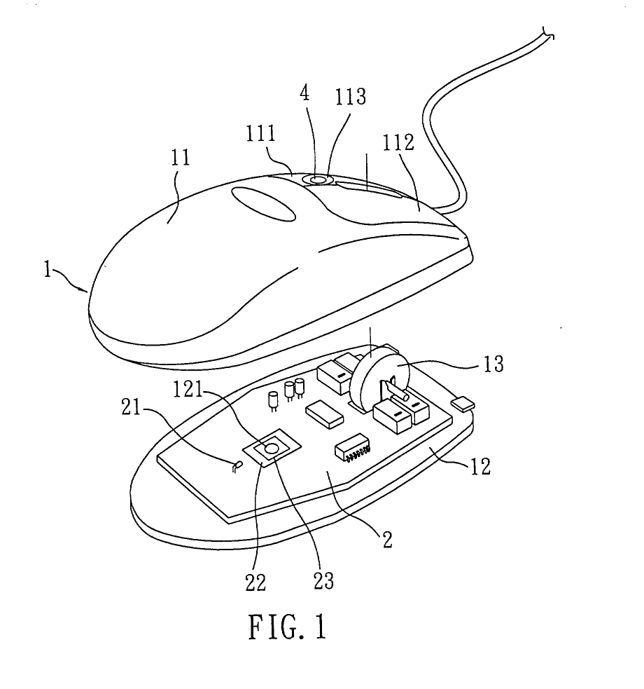

With reference to FIG. 1, there is shown an exploded view of a photo-mouse capable of detecting physiological signal and environmental luminance in accordance with a preferred embodiment of the present invention, which includes a housing 1 and a PCB 2 (Print Circuit Board). The housing 1 includes a shell 11 and a base 12. The shell 11 includes two control buttons 111 and 112, a rim 13 partially protruded out the housing 11, and a recess 113. There is a photo sensor 4 arranged in the recess 113. In this preferred embodiment, the photo sensor 4 is a photo diode.

The above PCB 2 includes a light source 21 of the photo-mouse, a photo sensor chip 22, and others electric elements. In this preferred embodiment, the light source 21 of the photo-mouse is preferably a red LED, and the photo sensor chip 22 is preferably a CMOS sensor.

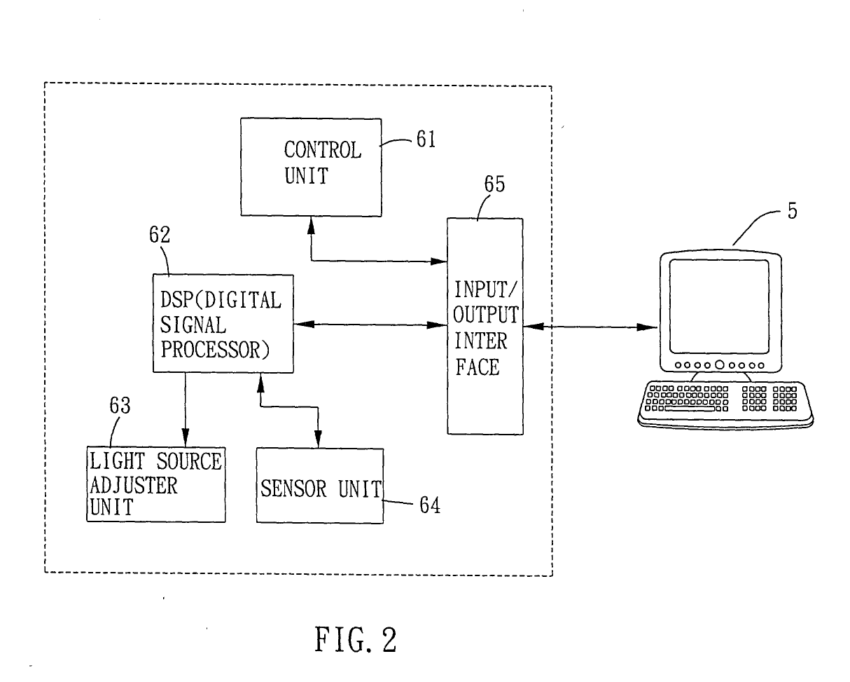

FIG. 2 is a functional block diagram of the mouse capable of detecting physiological signal and environmental luminance in accordance with the present invention, which includes a control unit 61, a DSP (Digital Signal Processor) 62, a light source adjuster unit 63, a sensor unit 64, and an input/output interface 65. In this preferred embodiment, the input/output interface 65 is an USB (universal Serial Bus) interface.

The operation of this preferred embodiment is described as bellow. With reference to FIG. 1 and FIG. 2, the control unit 61 produces plural signals based on receiving the operation of control buttons 111 and 112 or the rim 13, or the external photo signal received by the photo sensor chip 22. Then, the control unit 61 sends the signals to a computer 5 via the input/output interface 65, so as to generate the cursor movement or other instruction executing operation on the monitor of the computer 5, wherein the photo signal received by the photo sensor chip 22 is produced by the light source 21 of the photo-mouse. The photo signal passes through a hole 121 to a desktop, and is reflected by the desktop to pass through the hole 121 again, so as to reach the photo sensor chip 22 via a sensor hole 23.

The photo sensor unit 64 is provided to utilize the photo signal, resulting from the environmental light source and penetrating through the human finger, received by the photo sensor 4. When a user operates the photo-mouse, the user's finger is placed in the recess 113 that conforms to the human. The environmental light will pass the finger (and plural blood capillaries in the finger) to reach the photo sensor 4 for being processed by the photo sensor unit 4 (including a high pass filter processing and a low pass filter processing), and the photo sensor unit 4 sends the processed result to the DSP 62 to compute the number of the user's heartbeats and obtain the environmental luminance.

In addition to computing the number of the pulses, the DSP 62 also determines the quality of the photo signal that the photo sensor 4 received, and the DSP 62 adjusts the DC level of the photo sensor 4 via the light source adjuster unit 63, and the AC gain of the photo signal, so that the photo sensor 4 can detect the suitable photo signal in any environment to improve the efficiency of the power. When the DSP 62 has computed the number of the pulses and detected the environmental luminance, the DSP 62 sends the above result to the computer 5 by the input/output interface 6.

The computer 5 is installed with a driver or an application (AP) to show a friendly screen including the number of the human pluses and the environmental luminance. The AP records the number of the pluses for the user, so as to monitor the user's physiological state at any time and send a warning message to the user when the number of the pluses is abnormal.

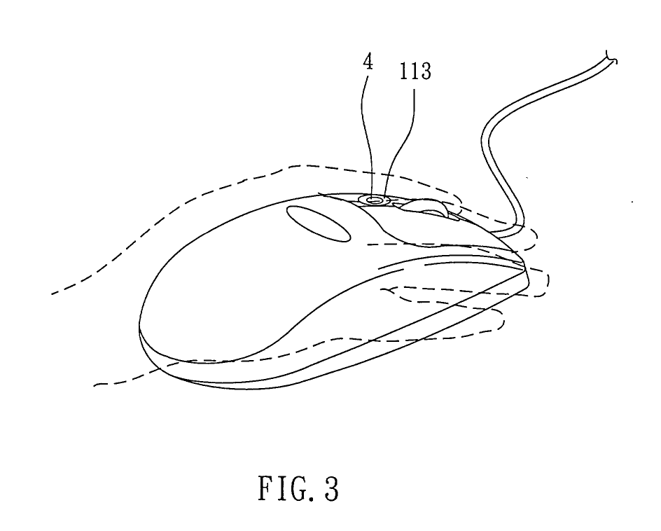

FIG. 3 shows that the user's finger is placed in the recess 113 when the user operates the photo-mouse. The environmental photo signal penetrates through the finger and is detected by the photo sensor 4, so as to measure the number of the pluses. Additionally, the above photo-mouse can be replaced by the traditional mechanical rolling-ball mouse, wherein the light source of the photo-mouse, the photo sensor chip, and other optical device are replaced by a roller or other mechanic devices, so as to produce a control signal of the cursor displacement.

In view of the foregoing, it is known that the mouse of the present invention utilizes the recess 113 on the housing 1 to hold the user's finger. The recess 113 has the photo sensor 4 for receiving the environmental photo signal that penetrates through the finger. The DSP 62 processes and transforms the photo signal into the human pluses and adjusts the DC level and AC gains of the light source signal based on the detected photo signal.

Although the present invention has been explained in relation to its preferred embodiment, it is to be understood that many other possible modifications and variations can be made without departing from the spirit and scope of the invention as hereinafter claimed.

What is claimed is:

1. A mouse capable of detecting physiological signal and environmental luminance, comprising:
a housing having a base and a shell fixed on the base, the shell having plural buttons, and a recess for receiving a human finger, the recess having a first photo sensor for detecting signal emitted from a light source; and
a printed circuit board for processing control signal generated by the plural buttons and receiving photo signal received by the first photo sensor, and sending the signals to a computer connected with the mouse via an input/output interface, such that the computer determines and displays human physiological state and based on the photo signals.

2. The mouse as claimed in claim 1, wherein the finger is placed on the first photo sensor.

3. The mouse as claimed in claim 2, wherein the light source is an environmental light source, and the photo signal generated by the environmental light source penetrates the finger to be received by the first photo sensor and sent to the computer.

4. The mouse as claimed in claim 1, wherein the printed circuit board has a digital signal processor for processing the photo signal received by the first photo sensor and sending the processed result to the computer by the input/output interface.

5. The mouse as claimed in claim 4, wherein the digital signal processor adjusts a DC level of the first photo sensor and an AC gain of the photo signal based on the photo signal received by the first photo sensor.

6. The mouse as claimed in claim 1, wherein the photo signal is transformed into human pulses for being displayed.

7. The mouse as claimed in claim 1, wherein the input/output interface is a universal serial bus interface.

8. The mouse as claimed in claim 1, which uses a standard mouse interface to move the cursor on the computer monitor, and the standard mouse has at least one control button and windows scroll function.
